(19) United States
(12) Patent Application Publication
(10) Pub. No.: US 2015/0223628 A1
(43) Pub. Date: Aug. 13, 2015

(54) PORTABLE BREWING DEVICE

(71) Applicant: Takeya USA Corporation, Huntington Beach, CA (US)

(72) Inventors: Edward Cheung, La Puente, CA (US); Yukio Ban, Osaka (JP)

(73) Assignee: Takeya USA Corporation, Huntington Beach, CA (US)

(21) Appl. No.: 14/177,111

(22) Filed: Feb. 10, 2014

Related U.S. Application Data
(63) Continuation-in-part of application No. 29/481,784, filed on Feb. 10, 2014.

(51) Int. Cl. A47J 31/02; A47J 31/00

(52) U.S. Cl. CPC A47J 31/02; A47J 31/005

(57) ABSTRACT

A portable brewing device includes a container and a top assembly removably attachable to the container. The top assembly is configured to receive a brewing agent and is fluidly connected to the container through a filter. When the device is flipped upside down, liquid can flow from the container body through the filter and into the top assembly. When the beverage has steeped a desired amount, the device can be turned right side up to separate the liquid from any remaining brewing agent. The top assembly can be removed and the beverage is now ready to be drunk from the container. An improved sealing system can be used to prevent leaks, particularly when the device is upside down. In addition, an improved filter system can allow for the quick and proper movement of liquid between the container and top assembly.

### CROSS-REFERENCE TO RELATED APPLICATIONS

This application is a continuation-in-part of U.S. patent application Ser. No. 29/481,784, filed Feb. 10, 2014. The entire contents of the above applications are hereby incorporated by reference and made a part of this specification. Any and all priority claims identified in the Application Data Sheet, or any correction thereto, are hereby incorporated by reference under 37 CFR 1.57.

### BACKGROUND OF THE DISCLOSURE

1. Field of the Disclosure

The disclosure relates to portable beverage makers, and more particularly to a container for selectively brewing or steeping beverages.

2. Description of the Related Art

Tea and other steeped beverages are customarily prepared by placing tea leaves or other brewing agents in hot or boiling water and allowing the water to steep with the brewing agent. Typically, screens or strainers, known as infusers, are used to filter the brewing agents from the water when consumed.

A variety of portable brewing devices exist, allowing for controlling the steeping time while still allowing for screening or straining of the brewing agents. However, present devices contain a variety of limitations and disadvantages.

### SUMMARY OF THE DISCLOSURE

Various embodiments described herein relate to portable brewing devices, such as devices that can be used to transport and brew tea or other beverages. This disclosure refers interchangeably to “brewing” and “steeping.” Because brewed beverages can gain in strength the longer they steep, the devices can be configured to allow a user to determine when brewing begins and how long the beverage should be steeped. For example, in some embodiments, a portable brewing device can include a top assembly that can be configured to retain a brewing agent, such as loose leaf tea, and the top assembly can be releasably connected to a container, thermos, or container body, which can retain a hot liquid, such as water. A filter can be positioned between the top assembly and the container body. In some embodiments, the filter can be connected to the top assembly, and in some embodiments the filter can be connected to the container body.

When the device is oriented with the filter above the container body, the liquid remains in the container body and the tea or other brewing agent does not infuse within the liquid. However, if the device is flipped upside down, the liquid can flow from the container body through the filter and into the top assembly, where it will mix with the brewing agent and begin to steep. The device can be left upside down to allow for continued steeping, or can be flipped up and down to increase the movement of water in and around the brewing agent. When the beverage has steeped a desired amount, the device can be turned right side up to again separate the liquid from any remaining brewing agent. The beverage is now ready to be drunk from the container. In some embodiments, the top assembly can be removed prior to drinking.

Various embodiments described herein can have a variety of features that help increase the ability of fluid within the container body to flow with minimal interruption into the top assembly when the device is flipped upside down. This is an improvement from various existing devices, which generally must be flipped slowly to allow fluid to flow to or from the container body into the top assembly. If these existing devices are flipped too quickly, air is trapped behind the filter preventing fluid from flowing to steep with the brewing agent. There may be various reasons why this occurs, such as the brewing agent blocking the filter or improper flow dynamics in the container.

Because portable brewing devices may rely on turning the device upside down in order to initiate the steeping process, it can be desirable to ensure that there is an adequate seal between the top assembly and the container body. Providing an appropriate seal can be difficult because the liquid positioned within the device is frequently at or near a boiling temperature, which creates steam and leads to a variety of pressure changes. Existing devices have not managed to develop an adequate seal. Various embodiments described herein are configured to provide functional seals such that fluid does not leak when the device is rotated to begin or to stop steeping. In some embodiments, the device can have multiple layers of seals, such that a fluid would need to pass more than one seal in order to leak. In some embodiments, a device can include seals that create a tighter seal when exposed to an increased pressure.

According to some embodiments, a portable brewing device includes a container and a top assembly removably attached to the container. The top assembly is configured to receive a brewing agent and is fluidly connected to the container through a filter. When the device is flipped upside down, liquid can flow from the container body through the filter and into the top assembly. When the beverage has steeped a desired amount, the device can be turned right side up to separate the liquid from any remaining brewing agent. The device may also include an improved sealing system to better prevent leaks, particularly when the device is upside down. In addition, or instead, the device may also include an improved filter system to allow for the quick and proper movement of liquid between the container and top assembly.

In various embodiments, a portable beverage steeping device configured to be flipped upside down for steeping and then to be flipped right side up for drinking when the beverage has been steeped a desired amount can include a container having a longitudinal axis, a bottom wall, and a side wall defining an interior space configured to receive liquid through an opening at a top of the container. The steeping device can also include a top assembly removably attached to the container at the top of the container to thereby form an enclosed and sealed device that can be flipped upside down and not spill out liquid from within the device, the top assembly including an upper cap at least partially defining a brewing area configured to receive a brewing agent, the brewing area and the interior space of the container in fluid communication with each other when the top assembly is attached to the container. The steeping device can also include a filter positioned between the interior space and the brewing area when the top assembly is attached to the container such that fluid passing between the top assembly and the brewing area passes through the filter, wherein the filter includes an open bottom and at least a portion of the filter extends from the open bottom into the brewing area.

In various embodiments, a portable beverage steeping device configured to be flipped upside down for steeping and then to be flipped right side up for drinking when the beverage has been steeped a desired amount can include a container having a bottom wall and a side wall having a top edge that defines an opening into an interior of the container. The device can also include a top assembly removably attached to the container to thereby form an enclosed and sealed device that can be flipped upside down and not spill out liquid from within the device, the top assembly including an upper cap at least partially defining a brewing area. The device can also include a filter configured to filter a fluid passing between the brewing area and the interior of the container, and a first gasket configured to contact an interior of the side wall of the container when the top assembly is attached to the container, the first gasket having a medial surface in fluid communication with an interior of the cylindrical container such that an increase of pressure on the medial surface increases a sealing force between the first gasket and the side wall.

In various embodiments, a portable beverage steeping device configured to be flipped upside down for steeping and then to be flipped right side up for drinking when the beverage has been steeped a desired amount can include a container having a longitudinal axis, a bottom wall, and a side wall defining an interior space configured to receive liquid through an opening at a top of the container. The device can also include a top assembly attachable to the container at the top of the container to thereby form an enclosed and sealed device that can be flipped upside down and not spill out liquid from within the device, the top assembly including an upper cap at least partially defining a brewing area configured to receive a brewing agent, the brewing area and the interior space of the container in fluid communication with each other when the top assembly is attached to the container. The device can also include a filter positioned between the interior space and the brewing area when the top assembly is attached to the container such that fluid passing between the top assembly and the brewing area passes through the filter. The filter can include a side wall and a top wall, the side wall having a generally straight profile and a filter area that allows fluid to pass through the side wall, and the top wall having a filter area that allows fluid to pass through the top wall.

### BRIEF DESCRIPTION OF THE DRAWINGS

FIG. 1 is a front perspective view of one embodiment of a portable brewing device;

FIG. 2 is a cross-sectional view of one embodiment of a portable brewing device;

FIG. 3 is an image of the brewing device of FIG. 2 partially disassembled;

FIG. 4 is an exploded perspective view of one embodiment of a top assembly of a portable brewing device;

FIG. 5 is a perspective view of one embodiment of a filter frame of a portable brewing device;

FIG. 6 is a top view of the filter frame of FIG. 5;

FIG. 7 is a bottom view of the filter frame of FIG. 5;

FIG. 8 is a front view of one embodiment of a filter of a portable brewing device;

FIG. 9 is a perspective view of one embodiment of a collar of a portable brewing device;

FIG. 10 is a bottom view of the collar of FIG. 9;

FIG. 11 is a cross-sectional view of one embodiment of a portion of a top assembly when connected to a container.

### DETAILED DESCRIPTION OF THE PREFERRED EMBODIMENTS

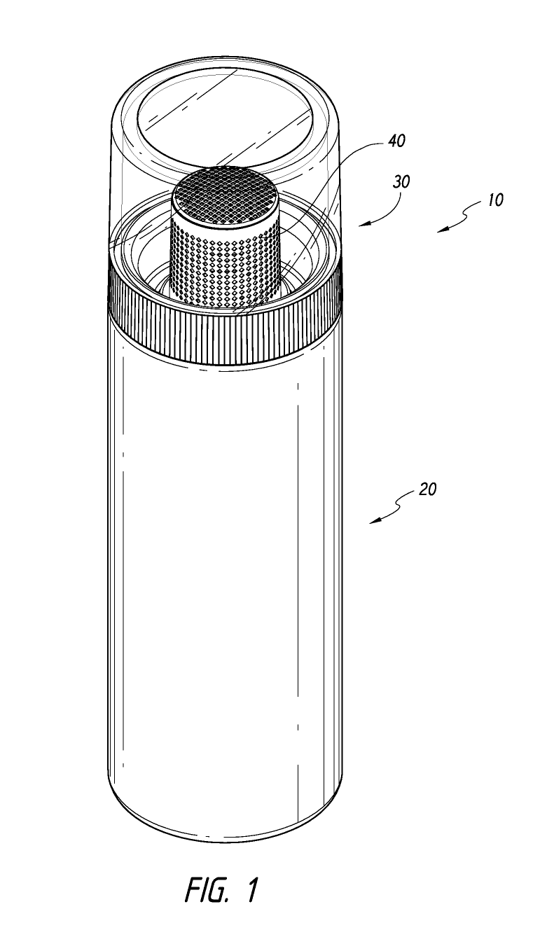

With reference to the attached figures, certain embodiments and examples of portable brewing devices will now be described. Generally, unless indicated to the contrary, the directional signifiers “up”/“down” and “top”/“bottom” refer to a portable brewing device and its various components as they are oriented in FIG. 1.

FIG. 1 illustrates one embodiment of a portable brewing device or tea tumbler 10. The device can include a container body 20 and a top assembly 30 that can be removably attached to the body. The device can also include a filter or infuser 40, which can be positioned between a fluid path connecting an interior of the container body 20 to an interior of the assembly 30, such that fluid passing from the assembly to the body or from the body to the assembly passes through the filter 40. In some embodiments, the filter can be part of the top assembly. In some embodiments, the filter can connect directly to the body.

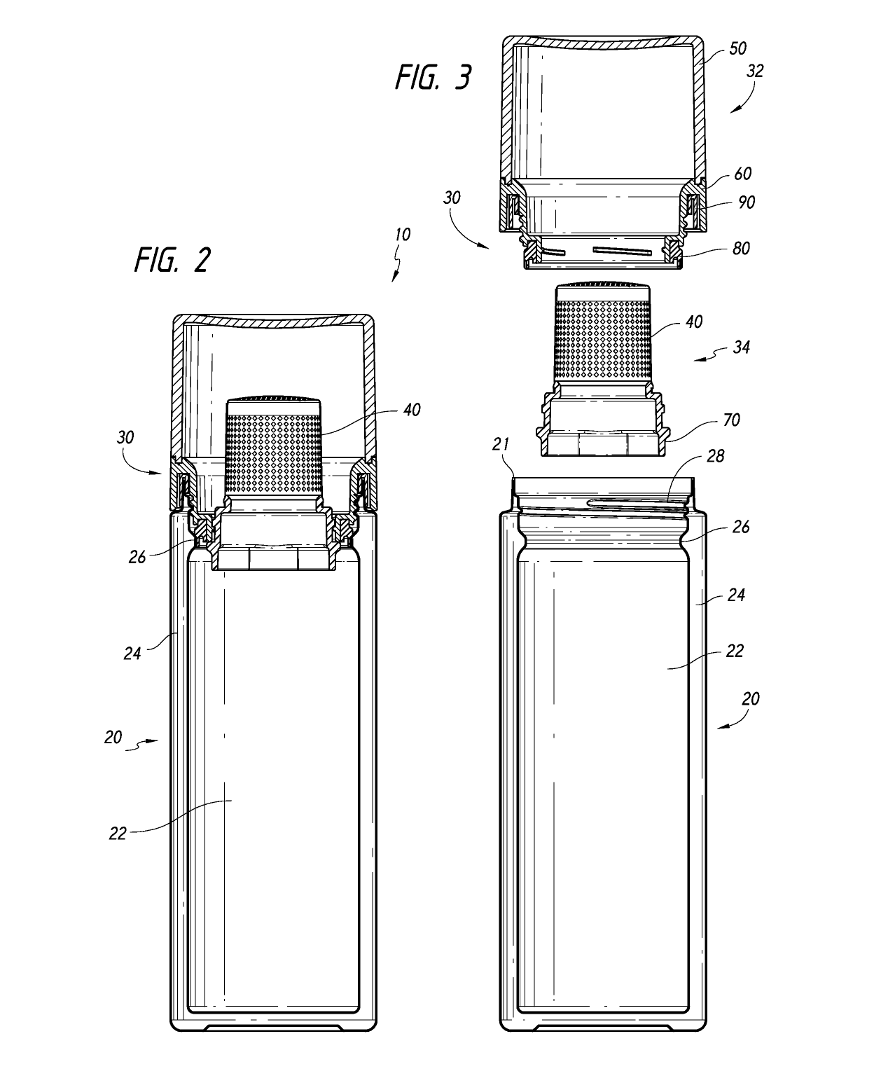

FIG. 2 illustrates a cross-section of a portable brewing device. The container body 20 can include an inner cavity or chamber 22 that can be configured to receive a fluid. In some embodiments, the body can also include an outer insulation layer, cavity, or chamber 24. The outer chamber can be positioned between inner and outer walls of the container body, and the outer chamber can be adapted to help minimize heat transfer between a fluid within the inner cavity 22 and an exterior of the device. For example, in some embodiments, the outer chamber 24 can be maintained at a pressure approximately equal to zero or substantially close to zero. In some embodiments, the outer chamber can be filled with an insulating material and/or a reflective material that resists radiative heat transfer. In some embodiments, the container body 20 can be formed partially or completely of a translucent material.

FIG. 3 illustrates the brewing device 10 when it has been partially disassembled. In some embodiments the top assembly 30 can include a cap assembly 32 and a filter or infuser assembly 34. The top assembly can be removable from the container body 20. In some embodiments, as illustrated, the top assembly can engage the container body with threading 28. In some embodiments, other or additional connections may be used, such as locking snaps, detents, etc.

When the top assembly is removed from the container body 20, a liquid, such as hot or boiling water, can be poured into the inner cavity 22 of the body. The filter or infuser assembly 34 can be removed from the cap assembly 32. A brewing agent, such as loose leaf tea, can then be inserted into the cap assembly and the filter or infuser assembly 34 can be returned into attachment with the cap assembly, thereby closing the brewing agent within the cap assembly 32. The top assembly 30 can then be reattached to the body 20, as illustrated in FIG. 2. Various attachment mechanisms between the top assembly 30 and container body 20, as well as between the filter assembly 34 and cap assembly 32, are described in more detail below.

Once the container body 20 contains liquid and a brewing agent has been inserted into the top assembly 30, the device is ready for brewing. Preferably, the top assembly 30 and the container body 20 are sized and configured such that the liquid within the container body will not mix with the brewing agent when the device 10 is oriented upright, as shown in FIG. 2. The brewing or steeping process can begin when the device is rotated to thereby allow liquid to flow from the body 20, through the filter 40, and into the cap assembly 32. Air that was within the cap assembly can be displaced through the filter 40 and into the body 20. In various embodiments described herein a filter can be designed to maximize the flow of liquid in one direction and air in a direction counter to the flow of liquid.

The liquid will continue to steep so long as the liquid and brewing agent remain within the cap assembly, but when the device is returned to the orientation of FIG. 2 the liquid will desirably return to the body, displacing air from the body back into the cap assembly, and the liquid will no longer steep. The top assembly 30 can then be removed from the body and steeped liquid can either be poured out of the container body 20 or can be drunk directly from the body.

In the illustrated embodiment, the filter assembly 34 includes a filter 40 and a filter frame 70. In some embodiments, the filter assembly 34 can include only the filter 40, which can attach directly to the cap assembly 32 and/or container body 20. The cap assembly 32 can include a cap 50, a collar 60, and one or more sealing gaskets, such as a first gasket 80 and a second gasket 90. In some embodiments, a second gasket 90 can be independent of the cap assembly and can be used to cover the lip 21 of the container body 20, as described below. In some embodiments, all or part of the cap can be formed of a translucent material. In some embodiments, the cap and collar can be molded together or later attached, such as with adhesive, sonic welding, or other attachment mechanism. In some embodiments, one or more sealing gaskets can be part of the filter assembly 34 and/or container body in addition to or instead of the gaskets in the cap assembly 32.

In some embodiments, the container body 20 and top assembly 30 can have various features that can help provide sealing surfaces to prevent liquid from leaking out of the device when it is rotated. For example, in some embodiments the container body can include an interior circumferential projection 26 at a top end of the body. The projection can be used to help create a seal between the top assembly 30 and the body 20, as described in more detail below. The body can also have an upper lip 21 that can be used as a sealing surface, also described in more detail below.

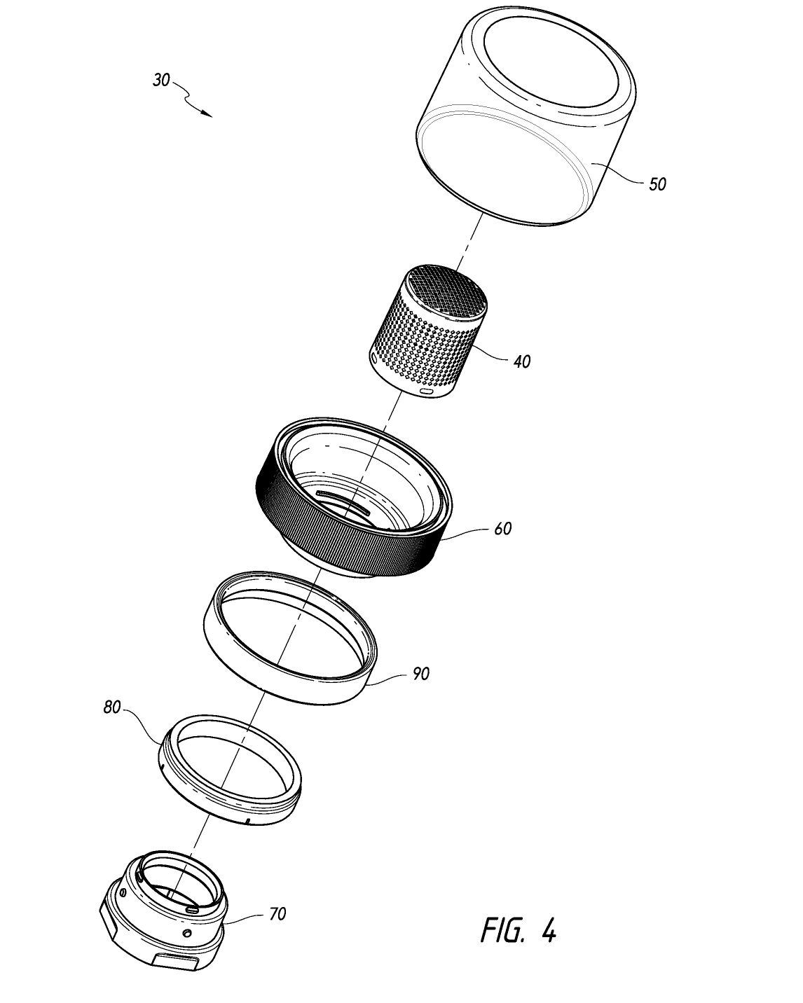

FIG. 4 illustrates an exploded perspective view of one embodiment of the top assembly 30. As described above, in some embodiments the top assembly can include a filter or infuser 40, a filter or infuser frame 70, a top cap 50, a collar 60, a first gasket 80, and a second gasket 90. These illustrated components can be generally cylindrical in shape and can be assembled about a longitudinal axis that can align with a longitudinal axis of the container body 20 when the top assembly 30 and container body are attached to each other.

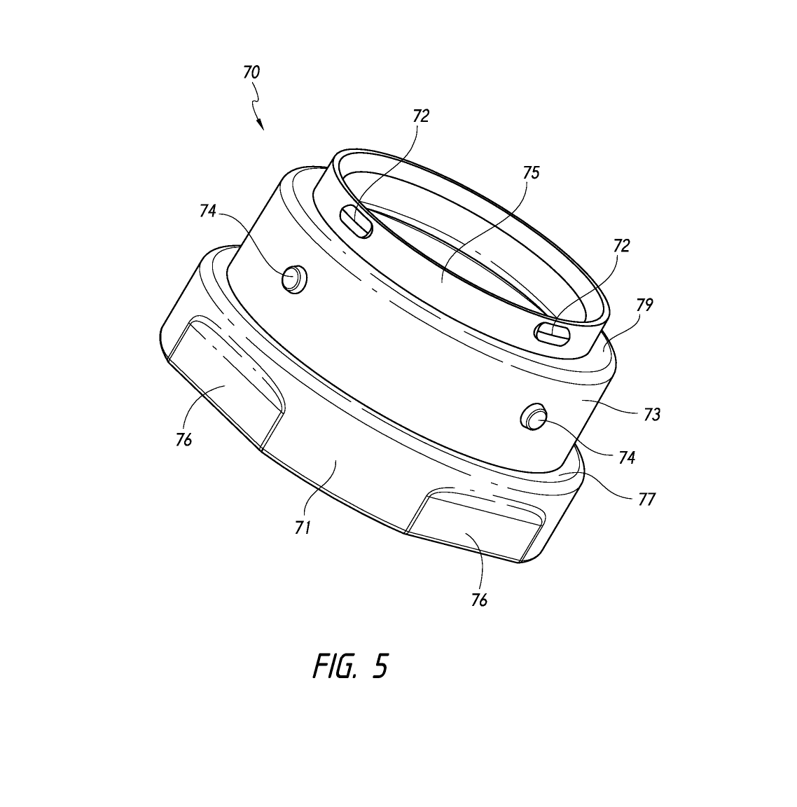

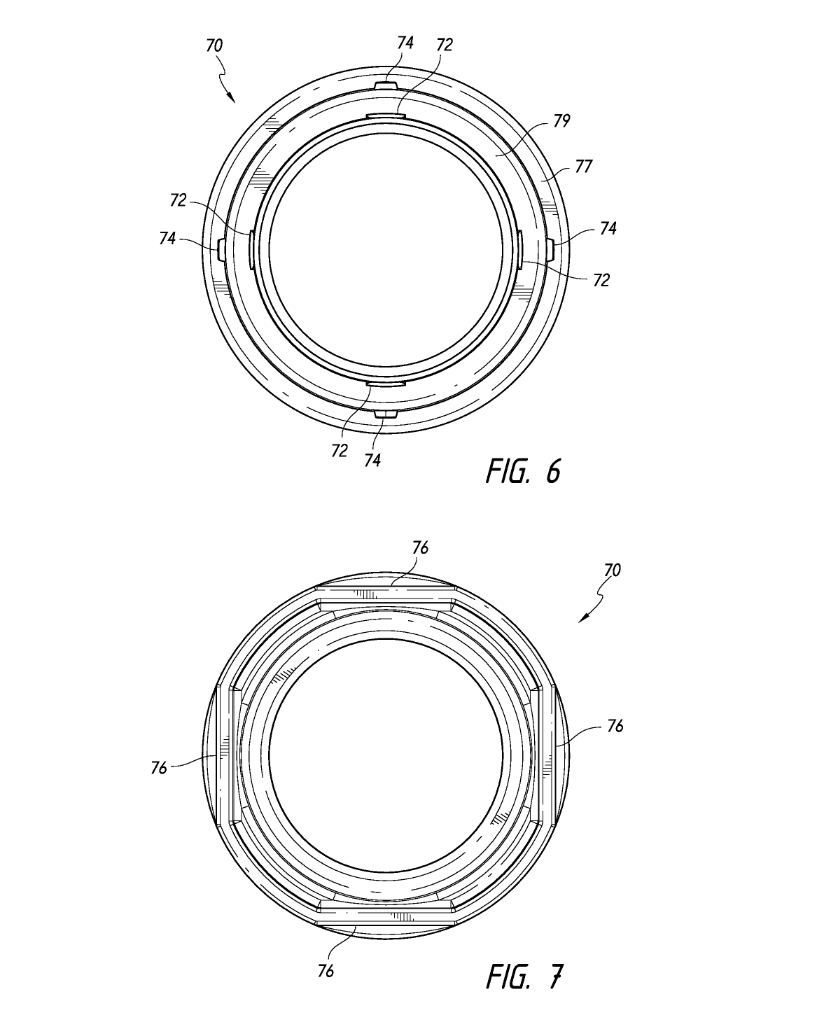

FIGS. 5-7 illustrate one embodiment of a filter or infuser frame 70. FIG. 5 is a perspective view and FIGS. 6 and 7 are top and bottom views, respectively. In some embodiments, the filter frame can have a plurality of sections of varying diameter. For example, in some embodiments the filter frame can have a first or bottom section 71 having a first diameter, a second or middle section 73 having a second diameter less than the first diameter, and a third or top section 75 having a third diameter less than the second diameter. A ledge can exist between each section, such as a first ledge 77 between the first and second sections and a second ledge 79 between the second and third sections. The ledges can help define the position of various components in an assembled top assembly. For example, in some embodiments, the second ledge 79 can help block a lower edge of a filter. In some embodiments, the first ledge 77 can abut or block a lower edge of the collar 60, preventing the filter frame 70 from being inserted too far into the cap assembly 32, as described in more detail below.

The filter frame 70 can have a variety of features configured to help the frame attach to other components of the top assembly 30. For example, in some embodiments, the filter frame can include a plurality of filter projections 72, which can be configured to attach the frame 70 to the filter or infuser 40. Similarly, in some embodiments, the filter frame can have a plurality of collar projections 74 that can be used to attach the frame to the collar. The projections 72, 74 are preferably positioned symmetrically about a circumference of the frame, as shown in FIG. 6. Varying numbers of projections can be used. In some embodiments, there can be four filter projections 72 and four collar projections 74. In some embodiments, there can be more or fewer. In some embodiments, the filter projections can be aligned with the collar projections, as shown. In some embodiments, there can be more filter projections than collar projections. In some embodiments, there can be fewer filter projections than collar projections.

In some embodiments, other forms of connection can be used between the filter frame 70 and the filter 40 and/or the collar 60. For example, in some embodiments, the filter frame can have a threaded connection with the filter or infuser 40 and/or the collar 60. In some embodiments where rotation is needed to disconnect the frame 70 from the collar to thereby disconnect the filter assembly from the cap assembly, the frame 70 can have one or more grip sections 76 which can be configured to help a user grip the frame. In some embodiments, the grip sections can be a plurality of flattened surfaces. In some embodiments, they can be textured to increase friction. In some embodiments, the grip sections 76 can be in the first or bottom section 71 of the frame 70. In some embodiments, the filter projections 72 can be positioned above the collar projections 74, as illustrated. In some embodiments, the filter projections can be positioned on the third or top section 75 and the collar projections can be on the second or middle section 77.

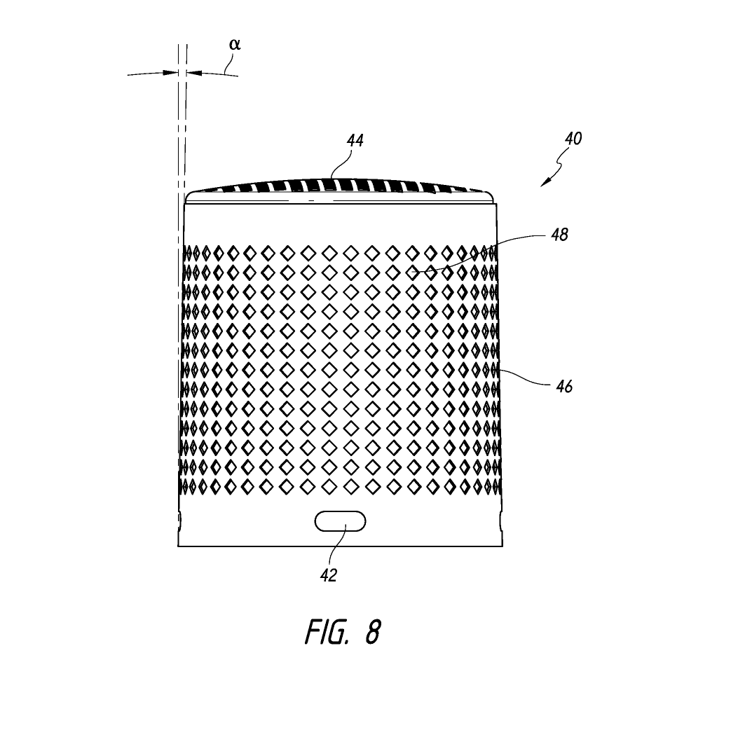

FIG. 8 illustrates one embodiment of a filter or infuser 40. The filter or infuser can have one or more apertures 42 that can be configured to receive corresponding projections 72 on the filter infuser frame 70, to thereby attach the filter to the frame. In some embodiments, as described above, the filter can instead have internal or external threading configured to mate with corresponding threading on the frame 70. Other connection methods are also possible.

The filter 40 can have a variety of features and structural designs configured to maximize the flow of fluid (e.g., liquid and/or air) through the filter. Preferably, the filter includes a side wall 46, a top wall 44, and an open bottom. The filter can be in the shape of a cylinder as shown, but can also be one of many different shapes, such as, but not limited to: rectangular, pyramid, triangular, trapezoidal, and spherical. Preferably, all or most of the side wall and the top wall have a filter construction that allows fluid to pass through, such as by being formed of a mesh and/or having a plurality of small apertures 48 that let fluid pass through but that prevent or substantially prevent brewing agents from passing through. This can help maximize the available surface area through which fluid can flow, which can help prevent brewing agents from blocking the filter and preventing flow of fluid. This can also allow fluid to pass through the filter 40 by flowing in different directions. For example, having side walls 46 with a filter construction allows fluid to pass through the filter with a directional component perpendicular to or substantially perpendicular to a longitudinal axis of the filter and of the device 10 (e.g., at least a portion of the side walls have a normal vector perpendicular to or substantially perpendicular to the longitudinal axis). Having a filter construction on the top wall 44 allows fluid to pass through the filter with a velocity component parallel to or substantially parallel to the longitudinal axis (e.g, at least a portion of the top wall has a normal vector parallel to or substantially parallel to the longitudinal axis).

In some embodiments, having a filter construction on both the side wall and the top wall can help with the exchange of liquid and air as the brewing device is rotated. For example, as the device is rotated between a position in which liquid can steep in the top assembly and a position in which the liquid has returned to the container body 20. The side wall can tend to have more liquid moving through it to and from the top assembly, and the top wall can tend to have more air moving through it from and to the top assembly. These different flow paths can help with the efficient displacement of air relative to a liquid in the device. When the device is rotated towards a steeping position the opposite will be true with air primarily flowing through the side wall and liquid flowing through the top wall.

In some embodiments, it can be desirable for the top wall 44 to have an arcuate profile, such that liquid passing through top wall can do so along a continuum of varying directions. In some embodiments, as illustrated, the top wall can have a convex shape, helping maximize flow through the filter. This can also help prevent brewing agents, such as loose leaf tea, from collecting on the top wall and blocking fluid flow when the device 10 is rotated from upside down to right-side up (FIG. 2). In some embodiments, the top wall can be generally flat.

In some embodiments, the side wall 46 can have a variety of profiles that can help maximize flow through the filter. For example, in some embodiments, for example as illustrated, the side wall can have a generally straight profile. In some embodiments, the side wall can have one or more curves along its profile. In some embodiments, as illustrated, it can be desirable for the side walls 46 to be angled a relative to the longitudinal axis of the filter 40 and of the device 10. Having angled side walls can increase the surface area of the side walls for a given filter height to help increase available space for fluid and/or air to pass through the filter. In some embodiments the side walls can be generally vertical and the angle α can be approximately zero.

In some embodiments, the area of the portion of the side walls 46 that allows fluid to filter through can be greater than the area of the top wall 44. In some embodiments, the ratio of this side wall area to the top wall area can be between 5 (or about 5) and 15 (or about 15). In some embodiments, the ratio can be between 8 (or about 8) and 12 (or about 12). In some embodiments, these ratio values can be for the area of the entire side wall, not just the portion of the side wall that allows fluid to filter through.

In some embodiments, the ratio of the area of the portion of the side walls 46 that allows fluid to filter through to the top wall area can vary depending on the size of the cap assembly 32 and the size of the container body 20. For example, a user will tend to put an amount of brewing agent in the cap assembly that reflects that amount of liquid that can be stored in the container body 20. Thus, a larger container body will tend to lead to greater amounts of brewing agent placed in the top assembly. When the device has been rotated to allow fluid to flow into the cap assembly to steep and then returned to an upright position (e.g., as shown in FIG. 2), the brewing agent can block a portion of the filter 40. Preferably, the ratio of the side wall area to the top wall area can increase where more brewing agent is expected. This can help ensure that at least a portion of the side wall that allows fluid to filter through can remain unconstricted by the brewing agent. This can help maintain an efficient exchange of fluids when the device is rotated to the upright position, with liquid tending to move through the side wall and air tending to move through the top wall. In some embodiments, the side wall can extend generally the entire length of a cavity within the top assembly. In other embodiments, the side wall can extend ⅔, ½, ⅓ or more of the entire length of the cavity within the top assembly.

In some embodiments, the filter 40 can have a variety of other shapes. In some embodiments, for example, the filter can have a generally spherical portion at an upper end of the filter above the apertures 42. In some embodiments, the filter can be generally conical and taper to a point instead of having a top wall 44.

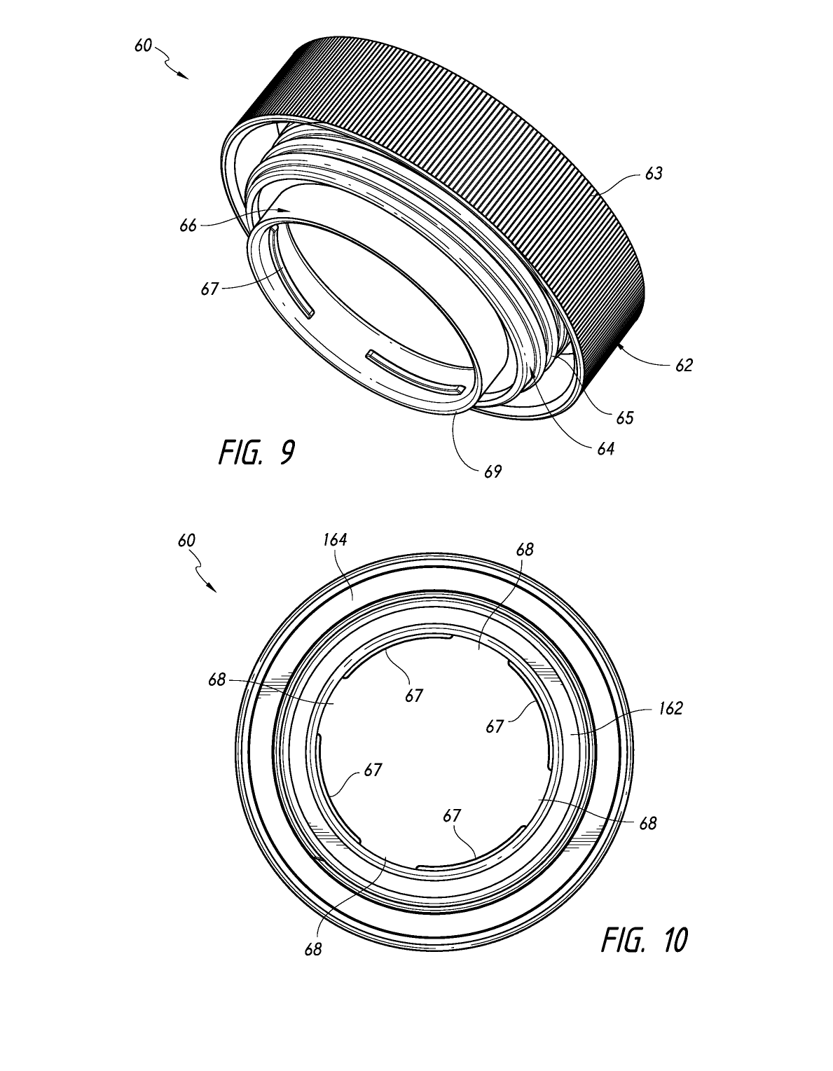

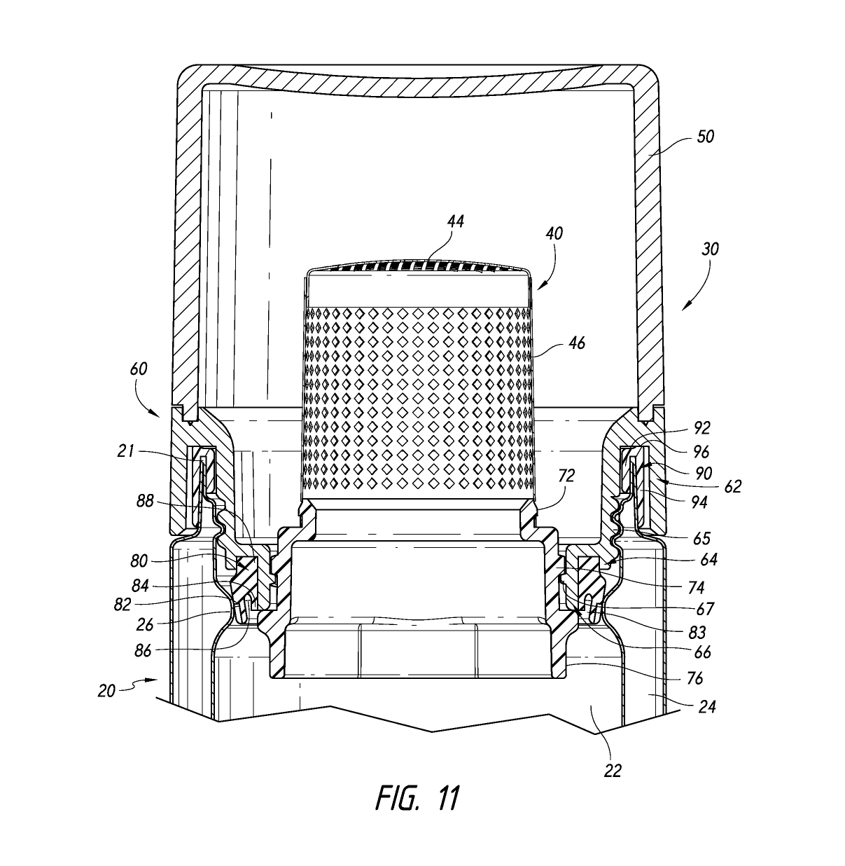

FIGS. 9 and 10 illustrate one embodiment of a collar 60. FIG. 9 is a bottom perspective view of the collar and FIG. 10 is a bottom view of the collar. In some embodiments, the collar can have a plurality of annular sections. For example, in some embodiments, the collar can have an inner ring 66, a second or central ring 64 with a diameter greater than that of the first ring 66, and a third or outer ring 62 with a diameter greater than the diameter of the second ring. In some embodiments, the rings can be spaced apart from each other to form gaps that can be used, for example, to receive and retain gaskets or other sealing mechanisms. For example, the illustrated embodiment includes a first gap 162 between the inner ring and central ring, and a second gap 164 between the central ring and the outer ring.

In some embodiments, the inner ring 66 can be configured to help attach the collar to the filter frame 70. For example, the inner ring can include one or more interior projections 67 that extend partially about a circumference of the inner ring 66. Preferably, the number of projections 67 corresponds to the number of collar projections 74 on the filter frame 70. The projections 67 can be spaced apart around a circumference of the inner 66 to form gaps 68 between the projections. Preferably, the gaps 68 are aligned such that the filter frame 70 can be inserted through the inner ring 66 with the collar projections 74 passing through the gaps 68. Once the collar projections 74 have been inserted past the projections 67, the collar 70 can be rotated until the collar projections 74 are each aligned with a corresponding projection 67 and not the a gap 68. This can prevent withdrawal of the filter frame 70, as the collar projections 74 will be blocked by the projections 67 if the frame is pulled back from the collar 60.

In some embodiments, the collar 60 and filter infuser frame 70 can be sized and configured such that when the frame 70 is being inserted into the collar 60, the lower edge 69 of the inner ring 66 will contact the ledge 77 between the first and second sections of the frame 70 when the collar projections 74 have completely passed through the gaps 68. This can help prevent inserting the frame too far into the collar 60.

In some embodiments, one of the rings of the collar 60 can have threading configured to engage the threading 28 on the container body 20, illustrated in FIG. 3. In some embodiments, the inner ring 66 can have threading configured to engage the threading 28 on the container body 20. In some embodiments, as illustrated, the second ring 64 can have threading 65 configured to engage threading in the container body 20. In some embodiments, the outer ring 62 that can have frictional features 63, such as ridges, flattened sections, bumps, or other surface textures that can help provide friction for a user gripping the collar 60 to screw or unscrew the collar from the body 20.

FIG. 11 illustrates a cross-sectional view of a portion of the top assembly 30 when connected to a container body 20. As illustrated and as described above, the top assembly can include a variety of features configured to help minimize possible leakage from the device 10 when in use. For example, in some embodiments the top assembly can include a first or lower gasket 80, which can provide an initial seal between the top assembly and the body 20. In some embodiments, the first gasket 80 can be attached to the collar 60 between the inner ring 66 and the middle ring 64. In some embodiments, the gasket can be molded with the collar or can be attached via an adhesive or other substance. The gasket 80 preferably includes an outer leg or extension 82 that extends downward from a top 88 of the gasket and is configured to contact an interior wall of the body 20. In some embodiments, the outer leg or extension 82 can contact a projection 26 in an interior of the body 20. The projection can push the outer leg or extension away from an equilibrium position. The gasket 80 can be formed of a resilient material such that the outer leg or extension 82 provides a resistive force on the projection 26, thereby improving the seal between the projection and the gasket 80.

In some embodiments, the outer leg or extension 82 can have a medial surface 83 that is in fluid communication with the inner cavity 22 of the body 20. An increase in pressure within the inner cavity 22 will increase the pressure on the medial surface, tending to push the outer leg or extension 82 more strongly against the inner surface of the container body 20 and thereby improving the seal between the gasket and the body. Thus, for example, when the device is turned upside down, the weight of any fluid on the gasket 80 will also tend to push the outer leg or extension 82 against an inner wall of the body 20. In some embodiments, the gasket can also have an inner leg or extension 84 and a cavity or recess 86 between the inner leg and the outer leg. Increased pressure within the cavity can similarly help tighten and secure the gasket into a sealing position.

In some embodiments, the top assembly can also or alternatively include an upper or second gasket 90. The second gasket can be attached to the collar 60 between the middle ring 64 and the outer ring 62. In some embodiments, the gasket can be molded with the collar or can be attached via an adhesive or other substance. In some embodiments, the second gasket can help provide an additional seal if fluid manages to pass the first gasket 80. The second gasket 90 can be configured to seal against the upper lip 21 of the body 20. As the top assembly is tightened against the container body 20, such as by screwing the collar 60 further into the body, the gasket is pressed more tightly against the upper lip 21, thereby increasing the seal between the gasket and the body 20. Tightening the top assembly can also seal the gasket against the collar 60. In some embodiments, the second gasket can have an annular projection 96 on its top surface that helps create a seal with the collar.

In some embodiments, the second gasket 90 can be separate from the top assembly and can be used, for example, to provide a cushioned drinking area for users that do not prefer to drink directly from an uncushioned rim of the container body. In such embodiments, the second gasket can still help provide a sealing function, as described above. The second gasket can be attached to the rim via an adhesive or other substance. In some embodiments, the second gasket can be removably seated on the upper lip 21 to allow for easy removal and/or washing.

In some embodiments, the second gasket 90 can include an inner leg or extension 92 and an outer leg or extension 94, the legs passing on either side of the lip 21. In some embodiments, one or more of the legs can be configured to seal against the walls of the lip as the top assembly is tightened against the container body. This can further improve the seal between the top assembly and the container body. In some embodiments, the legs can be of varying lengths. In some embodiments, the outer leg 94 can extend farther downward than the inner leg 92.

The various features of the first gasket 80 and the second gasket 90 can each help prevent leaks of fluid within the container body 20. In some embodiments, the device 10 may use only the first gasket or only the second gasket. In some embodiments, as illustrated, the device uses both gaskets to help ensure a level of redundancy for leak prevention that allows for confident use of the portable brewing device without concerns for leakage. Additionally, in some embodiments the threaded connection between the top assembly 30 and the container body 20 can also help prevent leaks.

The terms “approximately”, “about”, and “substantially” as used herein represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

Similarly, this method of disclosure is not to be interpreted as reflecting an intention that any claim require more features than are expressly recited in that claim. Rather, inventive aspects may lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A portable beverage steeping device configured to be flipped upside down for steeping and then to be flipped right side up for drinking when the beverage has been steeped a desired amount, the portable beverage steeping device comprising:
a container having a longitudinal axis, a bottom wall, and a side wall defining an interior space configured to receive liquid through an opening at a top of the container;
a top assembly removably attached to the container at the top of the container to thereby form an enclosed and sealed device that can be flipped upside down and not spill out liquid from within the device, the top assembly including an upper cap at least partially defining a brewing area configured to receive a brewing agent, the brewing area and the interior space of the container in fluid communication with each other when the top assembly is attached to the container; and
a filter positioned between the interior space and the brewing area when the top assembly is attached to the container such that fluid passing between the top assembly and the brewing area passes through the filter, wherein the filter includes an open bottom and at least a portion of the filter extends from the open bottom into the brewing area.

2. The device of claim 1, wherein the filter comprises a side wall and a top wall, the side wall having a filter area that allows fluid to pass through and the top wall having a filter area that allows fluid to pass through.

3. The device of claim 1, wherein the filter comprises a cylinder extending into the brewing area.

4. The device of claim 3, wherein the top wall is convex.

5. The device of claim 3, wherein the side walls are angled relative to the longitudinal axis.

6. The device of claim 1, wherein the filter is configured to allow fluid to pass through the filter with a directional component perpendicular to the longitudinal axis of the container.

7. The device of claim 6, wherein at least a portion of the filter is oriented to allow fluid to pass through the filter with a directional component parallel to the longitudinal axis of the container.

8. The device of claim 1, wherein the filter releasably attaches to the top assembly.

9. The device of claim 8, wherein the filter is configured to remain attached to the top assembly when the top assembly is removed from container.

10. The device of claim 1, wherein the top assembly comprises threading configured to mate with threading on the side wall of the container.

11. A portable beverage steeping device configured to be flipped upside down for steeping and then to be flipped right side up for drinking when the beverage has been steeped a desired amount, the portable beverage steeping device comprising:
a container having a longitudinal axis, a bottom wall, and a side wall defining an interior space configured to receive liquid through an opening at a top of the container;
a top assembly attachable to the container at the top of the container to thereby form an enclosed and sealed device that can be flipped upside down and not spill out liquid from within the device, the top assembly including an upper cap at least partially defining a brewing area configured to receive a brewing agent, the brewing area and the interior space of the container in fluid communication with each other when the top assembly is attached to the container; and
a filter positioned between the interior space and the brewing area when the top assembly is attached to the container such that fluid passing between the top assembly and the brewing area passes through the filter, wherein the filter comprises a side wall and a top wall, the side wall having a generally straight profile and a filter area that allows fluid to pass through the side wall, and the top wall having a filter area that allows fluid to pass through the top wall.

12. The device of claim 11, wherein the top wall is convex.

13. The device of claim 11, wherein the ratio of the side wall filter area to the top wall filter area is between 5 and 15.

14. The device of claim 11, wherein the side wall is angled relative to the longitudinal axis.

15. A portable beverage steeping device configured to be flipped upside down for steeping and then to be flipped right side up for drinking when the beverage has been steeped a desired amount, the portable beverage steeping device comprising:
a container having a bottom wall and a side wall having a top edge that defines an opening into an interior of the container;
a top assembly removably attached to the container to thereby form an enclosed and sealed device that can be flipped upside down and not spill out liquid from within the device, the top assembly including an upper cap at least partially defining a brewing area;
a filter configured to filter a fluid passing between the brewing area and the interior of the container; and
a first gasket configured to contact an interior of the side wall of the container when the top assembly is attached to the container, the first gasket having a medial surface in fluid communication with an interior of the cylindrical container such that an increase of pressure on the medial surface increases a sealing force between the first gasket and the side wall.

16. The device of claim 15, wherein flipping the enclosed and sealed device upside down when liquid is within the container increases the pressure on the medial surface of the first gasket.

17. The device of claim 15, wherein the first gasket contacts the side wall of the container along a complete circumference of an interior of the side wall.

18. The device of claim 15, wherein the first gasket comprises a projection and the medial surface is a medial surface of the projection.

19. The device of claim 15, wherein the side wall comprises an internal circumferential projection on an interior of the side wall, the internal circumferential projection configured to contact the first gasket when the top assembly is attached to the container.

20. The device of claim 19, wherein the internal circumferential projection biases at least a portion of the first gasket radially inward.

21. The device of claim 15, further comprising a second gasket configured to seat on the top edge of the container when the top assembly is attached to the container.
